(19) United States
(12) Patent Application Publication
(10) Pub. No.: US 2011/0255589 A1
(43) Pub. Date: Oct. 20, 2011

(54) Methods of compressing data and methods of assessing the same

(75) Inventors: Steven E. Saunders, Cupertino, CA (US); John D. Ralston, Portola Valley, CA (US); Lazar M. Bivolarski, Cupertino, CA (US); Mina Ayman Makar, Stanford, CA (US); Ching Yin Derek Pang, Stanford, CA (US); John S. Y. Ho, Cupertino, CA (US)

(73) Assignee: Droplet Technology, Inc., Palo Alto, CA (US)

(21) Appl. No.: 12/806,055

(22) Filed: Aug. 3, 2010

Related U.S. Application Data
(60) Provisional application No. 61/231,015, filed on Aug. 3, 2009.

(51) Int. Cl. H04N 7/26

(52) U.S. Cl. 375/240.01; 375/E07.026

(57) ABSTRACT

In a number of embodiments, methods for compressing video data are disclosed. In addition, in a number of embodiments, methods for assessing the quality of compressed videos are disclosed.

### CROSS-REFERENCE TO RELATED APPLICATIONS

This application is a non-provisional patent application of U.S. Patent Application 61/231,015, filed on Aug. 3, 2009 and of U.S. Provisional Patent Application entitled “DYNAMIC PROCESS SELECTION IN VIDEO COMPRESSION SYSTEMS, METHODS AND APPARATUS”, filed on Apr. 12, 2010. The contents of the disclosures listed above are incorporated herein by reference.

### FIELD OF THE INVENTION

This invention relates generally to methods of compressing video data. More particularly, the invention relates to methods of compressing video data using visual aspects.

### DESCRIPTION OF THE BACKGROUND

The use of simple quantitative measurements such as RMSE and PSNR as video quality metrics implies an assumption that a human observer is sensitive only to the summed squared deviations between pixel brightness (luma) and color (chroma) values in reference and test sequences, and is not sensitive to other important aspects of an image sequence, such as the spatial and temporal frequencies of the deviations, as well as differences in the response to luma and chroma deviations.

PSNR measurements are certainly helpful in diagnosing defects in video processing hardware and software. PSNR is simple to calculate, has a clear physical meaning, and is mathematically easy to deal with for optimization purposes. Changes in PSNR values also give a general indication of changes in picture quality. However, human visual perception is not equivalent to the simple noise detection process described above. It is well-known that PSNR measurements do not incorporate any description of the many subjective degradations that can be perceived by human observers, and therefore are not able to consistently predict human viewers' subjective picture quality ratings. Ultimately, human perception is the more appropriate and relevant benchmark, hence the goal of defining an improved objective metric must be to rigorously account for the characteristics of human visual perception in order to achieve better correlation with subjective evaluations.

Another shortcoming of PSNR, and of traditional video codecs, is that they treat the entire scene uniformly, assuming that people view every pixel of each image in a video sequence uniformly. In reality, human observers focus only on particular areas of the scene, a behavior that has important implications on the way the video should be processed and analyzed. Even relatively simple empirical corrections to PSNR that take into account such non-uniformities have been shown to improve the correlation with mean opinion score (MOS) scores.

The evolution of today's video codecs has largely ignored the computational complexity and bandwidth constraints of wireless or Internet based real-time video communication services using devices such as cell phones or webcams. Standard broadcast video codecs such as, for example, MPEG-1/2/4 and H.264 have evolved primarily to meet the requirements of the motion picture and broadcast industries (MPEG working group of ISO/IEC), where high-complexity studio encoding can be utilized to create highly-compressed master copies that are then broadcast one-way for playback using less-expensive, lower-complexity consumer devices for decoding and playback. The above applications implicitly assume that video in general is created and compressed in advance of a user requesting to receive and view it (non-real time encoding, often multi-pass encoding), using professional server equipment (not computationally-constrained), and that the video is transmitted in one direction (not two-way), via a high-data-rate downlink from the content owner or distributor to the viewing device. The resulting codecs are highly asymmetric, with the encoder complexity, cost, and power consumption all significantly larger than those of the decoder. Furthermore, the computational complexity of the decoder alone can exceed the processor resources of most cell phones for full-size, full-frame-rate video.

### BRIEF DESCRIPTION OF THE DRAWINGS

To facilitate further description of the embodiments, the following drawings are provided in which:

FIG. 1 illustrates an example of a method of compressing video data according to one embodiment;

FIG. 2 illustrates an example of a method of determining the degree of similarity between two video according to another embodiment;

FIG. 3 illustrates an example of a method of determining the quality of similarity between two video according to another embodiment;

FIG. 4 illustrates the performance of an example of the embodiment of FIG. 3;

FIG. 5 illustrates an example of a method of determining the quality of similarity between two video according to another embodiment;

FIG. 6 illustrates an example of an algorithm;

FIG. 7 illustrates an example of the performance of a method of compressing video data; and

FIG. 8 illustrates an example of a screenshot of a mobile device implementing the method of FIG. 7.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein. The term “on,” as used herein, is defined as on, at, or otherwise adjacent to or next to or over.

The terms “couple,” “coupled,” “couples,” “coupling,” and the like should be broadly understood and refer to connecting two or more elements or signals, electrically and/or mechanically, either directly or indirectly through intervening circuitry and/or elements. Two or more electrical elements may be electrically coupled, either direct or indirectly, but not be mechanically coupled; two or more mechanical elements may be mechanically coupled, either direct or indirectly, but not be electrically coupled; two or more electrical elements may be mechanically coupled, directly or indirectly, but not be electrically coupled. Coupling (whether only mechanical, only electrical, or both) may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable. For example, the recitation of a first electrical device being coupled to a second electrical device does not mean that the first electrical device cannot be removed (readily or otherwise) from, or that it is permanently connected to, the second electrical device.

### DETAILED DESCRIPTION OF EXAMPLES OF EMBODIMENTS

In some embodiments of the present invention, methods of compressing video data are disclosed. The methods include using behavioral aspects of the human visual system (HVS) in response to images and sequences of images when compressing video data. As opposed to compression methods that treat every pixel of each image in a video sequence uniformly, methods presented herein can treat different areas of an image differently. As an example, certain areas of a frame may be more noticeable to the HVS; therefore, the codec used to compress the frame can be adjusted to reflect the importance of those areas compared to the less noticeable areas during compression. As another example, errors or changes of a frame during compression may be more noticeable in one area of a frame compared to another area of the frame. Therefore, the codec used to compress the frame can be adjusted to reflect the importance of those areas compared to the less noticeable areas during compression.

In addition, to a codec, as described above, HVS can be used to determine the quality of a compressed video as compared to the original video. As an example, certain areas of a frame may be more noticeable to the HVS; therefore, the quality measurement will give more weight to areas in which errors may be more noticeable or perceptible than areas in which the errors will be less noticeable or perceptible.

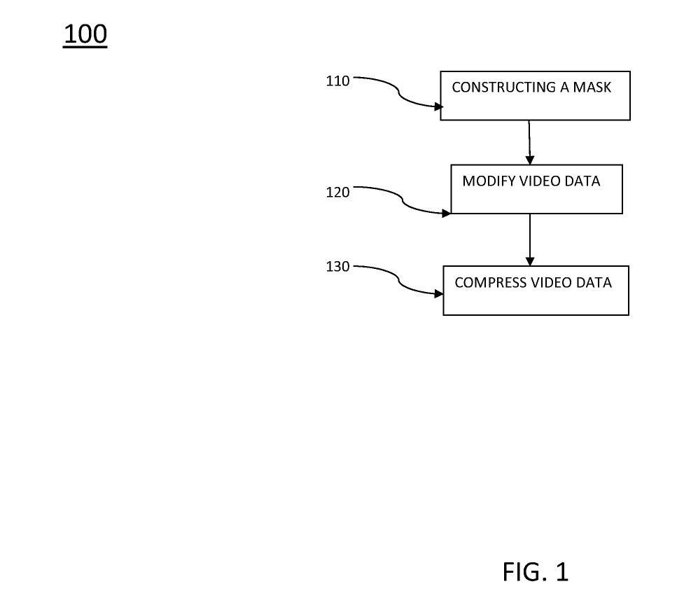

Turning to the drawings, FIG. 1 illustrates an example of a method 100 of compressing video data according to one embodiment. Method 100 can also be considered a method of compressing video data while considering the behavioral aspects of the HVS when viewing an image or sequence of images. Method 100 is merely exemplary and is not limited to the embodiments presented herein. Method 100 can be employed in many different embodiments or examples not specifically depicted or described herein.

Method 100 includes a procedure 110 of constructing a mask. A mask can be used to determine how much the HVS will perceive or notice a change or error between a referenced video and a processed video. For example, a mask can be used to determine whether a particular area of a frame of video is more or less perceivable or noticeable to a human eye when compared to the other areas within that frame. For each frame of a video, a respective mask may have a weighted value for each area within the frame. This value will indicate how easily a human will perceive a change or error in each area of the frame. Or the value will indicate how large of a change or error must be to become perceptible or noticeable (the Just Noticeable Difference (JND)).

In one embodiment, “the mask” comprises all of the channel masks combined in the way that the three visual channels are combined into a color image. In another embodiment, “a mask” can comprise just one channel perceptibility influence map; and there can be more than one mask for each video.

Saliency and perceptibility are examples of two types of considerations that can be used in the creation of the mask. Saliency refers to the reality that human observers do not focus on each area of a frame of a video equally. Instead, human observers often focus only particular areas within each frame. Perceptibility refers to use of certain aspects of HVS modeling, such as, for example, spatial, temporal, intensity dependent sensitivities to chrominance, luminance, contrast and structure.

In one embodiment, perceptibility considerations are used to create the mask of procedure 110. A number of different perceptibility characteristics can be used to create the mask. Examples of such characteristics include color, contrast, motion, and other changes.

A mask using perceptibility considerations represents the perceptibility of change or error to the HVS at each place in the area of the mask. Conceptually a mask exists or could be defined for each pair of perceptual channels over the visual field. Practically, we choose a limited number of masks for those channel combinations that show strong effects and are easy to measure.

A mask is like an image or frame of video data, in that it is a map giving the value of a quantity, the perceptibility or noticeability of changes in a visual channel, at each point in its area. Like images themselves, a mask has a limited resolution.

In addition, a mask may embody information that is gathered temporally, across a range of times. For example it may include motion information that is derived from analyzing several image frames together.

One example of a perceptibility characteristic is color. Color can include more than one measure or “channel”. A channel is a quality that can be measured or changed separately from other such qualities. For example, color often includes that combination of brightness/lightness and two chromaticity measures, such as, for example, blueness and redness. As such, color is generally considered to consist of three channels.

Traditionally, color representations are scaled by convention to roughly follow the logarithmic brightness perceptibility law by which the just-noticeable difference (JND) or just noticeable change in brightness is proportional to the brightness before the change, in linear physical units. But for video this scaling is usually made by the “gamma” curve given by picture tubes: brightness is proportional to a power “gamma” of the signal input, where gamma is conventionally taken to be 2.5. This leads to a power-law scaling with exponent 1/2.5=0.4, rather than a logarithmic scaling.

A better metric represents brightness in physical terms and calculates perceptibility on a JND scale derived from measured human responses. Such a scale is “perceptually uniform”.

Chromaticity has a different JND structure entirely, not logarithmic in nature, since “uncolored” is qualitatively different from “absolutely black” in perception; chromaticity is traditionally described by opponent colors (such as, for example, blue vs. yellow) rather than a single magnitude (such as brightness). A better metric represents chromaticity in physical terms and calculates perceptibility on a JND scale derived from measured human responses.

The brightness and the chromaticities can be combined into a single uniform scale. For example, a combined perceptually uniform scale for color is the “Lab” scale. DeltaE200 is a perceptually uniform (JND based) color difference scale.

As a general matter of channels—a local property of one channel may mask perceptibility in the same channel, as with the brightness JND discussion above, or it may mask perceptibility in a different channel, as seen below.

Another perceptibility characteristic can include contrast. In the presence of high local contrast—strong edges, for example, or “loud plaid”, or any strongly visible texture—small differences in brightness become less perceptible. Contrast masking may be directional, if the masking edges or texture is strongly directional. For example, a pattern of strong vertical stripes may mask changes in the same direction more strongly than changes in the crosswise direction.

Yet another perceptibility characteristic can include motion. Change in visual images is not always seen as motion—for example, fading in or out, or a jump cut. When an area or object is seen as being in motion (and not being tracked by the eyes), details of that area or object are less readily perceived. That is, motion masks detail. The overall level of brightness or color is not masked, but small local changes in brightness and/or color are masked.

Other types of changes (other than motion) can also be considered perceptibility characteristics. For example, a local flickering or textural twinkling can have a masking effect on brightness levels.

Method 900 demonstrates an example of a method of generating a saliency mask (map).

After procedure 110, method 100 (FIG. 1) continues with an optional procedure 120 of modifying the video data. After creation of a mask, as seen above, the mask can be used to modify the video data before compression occurs, thereby making compression of the video data simpler.

As an example, if the mask indicates that a particular area of a frame will be less perceptible/salient to a viewer than other areas, then that area may be preblurred before any compression occurs. In such an example, the sharpness of that area can be decreased.

In another example, if the mask indicates that a particular area of a frame will be less perceptible/salient to a viewer than other areas, then that area may be prescaled.

In another example, the mask can be used to precondition the choice among each codec used in the compression procedure (procedure 130) of method 100. In such an instance, the mask can be used to indicate preconditioning that needs to occur in each area of the frame, in order for the codec that will be run for that respective area. In application preconditioning of portions or all of a frame can be carried out as indicated by one or more of the masks.

In some embodiments the preconditioning includes applying a blurring filter to some or all portions of a frame, adjusting, including dynamically adjusting, the strength of the blurring filter to various portions or all of the frame. Varying amounts of blurring can be applied to separate portions of the frame in conjunction with the respective HVS value weighting for the portions, with portions having a lower HVS value weighting being blurred more than those portions having a higher HVS value weighting.

Method 1400 illustrates an example of pre-conditioning video using a saliency mask (map).

After procedure 120, method 100 (FIG. 1) continues with a procedure 130 of compressing the video data. The video data can be compressed with a codec.

In some embodiments, the mask created in procedure 110 can be used to affect the codec (or codecs) used in the compression of procedure 130. As an example, if the mask indicates that a particular area of a frame will be less perceptible/salient to a viewer than other areas, then the codec does not need to be as precise in the compression of the video data. For example, if there is a small error in brightness of a color and that small error won't be perceptible to the human viewer, then the compression of that area of the frame does not need to be as precise as another area. Therefore, the codec can be altered to be “more efficient” by using the greater resources for the more noticeable portions of each frame.

Types of changes or variations in the codec operation, that can be applied such as by region by region in a frame, and that can be dictated, guided, or informed by one or more of the masks include adjusting the quantization of the frame by region (such as applying a more coarse quantization to regions having a relatively low HVS weighting value in the mask and applying a less coarse quantization to regions having a relatively high HVS weighting value—and also dynamically adjusting the degree of coarseness across the frame as indicated by the respective HVS weighting value of one or more of the masks), adjusting quantization by quantization by subband, adjusting the codec effort spent in motion estimation region by region, adjusting the motion estimation search range, adjusting the degree of sub-pel refinement region by region, adjusting thresholds for “early termination” in motion estimation region by region, skipping motion estimation region by region for some frames, adjusting efforts spent by the codec in predictor construction for motion estimation as well as other techniques described elsewhere herein. Additional variations include applying distinct and different codecs to separate regions of the frame such as using a codec with a relatively reduced complexity (such as requiring relatively less processor resources) encoding regions having a lower HVS value weighting and using one or more codecs having respectively increased complexity (such as requiring relatively more processor resources) encoding regions having higher HVS value weightings.

In another example, the mask can be used to determine which codec will be used for each area of a frame. In such an example, certain codecs will be used in different areas of the codec according to the mask. As an example, if the mask indicates that a particular area of a frame will be less perceptible/salient to a viewer than other areas, one codec will be used. On the other hand, if the mask indicates that a particular area of a frame will be more perceptible/salient to a viewer than other areas, a different codec will be used. Any number of codecs can be used in such a situation.

After the video data has been compressed according to the mask, procedure 130 and method 100 are finished.

An example of the use of a saliency mask (map) being applied to a video codec is shown later.

In another embodiment, other considerations can be used in the compression of video data.

In some embodiments, a transform is used in order to produce a transformed image whose frequency domain elements are de-correlated, and whose large magnitude coefficients are concentrated in as small a region as possible of the transformed image. By statistically concentrating the most important image information in this manner, the transform enables subsequent compression via quantization and entropy coding to reduce the number of coefficients required to generate a decoded version of the video sequence with minimal detectable measured and/or perceptual distortion. An orthogonal transform (or approximately orthogonal) can be used in many instances in order to decompose the image into uncorrelated components projected on the orthogonal basis of the transform, since subsequent quantization of these orthogonal component coefficients distributes noise in a least-squares optimal sense throughout the transformed image.

In addition, low-complexity DWT algorithms, combined with a new codec architecture that also migrates motion estimation and compensation to the wavelet domain (i.e. 3D-DWT), can solve these problems. The use of such multi-dimensional transforms that incorporate motion processing provide significant overall reductions in computational complexity, compared to video codecs that utilize separate block-search temporal compression.

Some embodiments comprise codecs that utilize Just Noticeable Difference (“JND”)-based transforms, and thereby incorporate more comprehensive HVS models for quantization. These codecs may expand or take into account various components of the HVS model, including such as, for example, spatial, temporal, and/or intensity-dependent sensitivities to chrominance, luminance, contrast, and structure. Other embodiments utilize multiple transforms, such as combined DCT and DWT transforms. Further embodiments may utilize frequency domain processing for components that heretofore were spatially processed, such as using intra-frame DCT transform coefficients for faster block search in motion estimation algorithms of the codec.

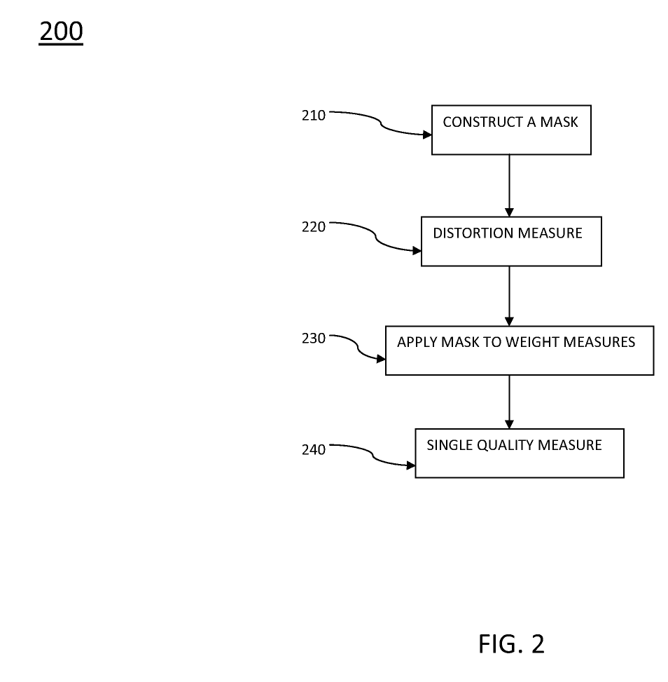

FIG. 2 illustrates an example of a method 200 of determining the degree of similarity between two video according to one embodiment. Method 200 can also be considered a method of comparing compressed video data to the original video data while considering the behavioral aspects of the HSV when viewing an image or sequence of images. In some embodiments, method 200 can be considered a video quality metric. Method 200 is merely exemplary and is not limited to the embodiments presented herein. Method 200 can be employed in many different embodiments or examples not specifically depicted or described herein.

Method 200 includes a procedure 210 of constructing a mask. A mask can be used to determine how much the HVS will perceive or notice a change or error between a referenced video and a processed video. For example, a mask can be used to determine whether a particular area of a frame of video is more or less noticeable to a human eye when compared to the other areas within that frame. For each frame of a video, a respective mask may have a weighted value for each area within the frame. This value will indicate how easily a human will notice a change or error in each area of the frame. Procedure 210 can be the same as or similar to procedure 110 of method 100 (FIG. 1).

Next, method 200 continues with a procedure 220 of deriving an area by area distortion measure between the two videos. Procedure 220 is used to determine the amount of distortion between the original video and the compressed version of the video. Each area of a frame of compressed video is compared to its respective area in the respective frame of the original video and a numerical value is determined for the level of distortion.

Subsequently, method 200 comprises a procedure 230 of applying the mask to weight the individual area measurements. As one example, each area of a frame can be weighted on a scale of zero to one. Zero indicates that a particular change from the original video to the compressed video in a particular area of the frame is not noticeable to a human viewer. One indicates that a particular change from the original video to the compressed video in a particular area of the frame is very noticeable to a human viewer.

Next, the level of distortion determined during procedure 220 for each area of a frame is multiplied by the respective weight for that particular frame. This will give each area of a frame a weighted level of distortion.

Thereafter, method 200 continues with a procedure 240 of combining the weighted measurements into a single quality measure for the two videos. As an example, the values of each area of each frame can be combined into a single value for each frame. Next, the value for each frame can be combined into a single value for the video sequence. In addition, if there are multiple channels in a single area, these values can be combined for each area, frame, and/or video sequence.

Additionally, there are numerous possibilities for the combining steps listed above. For example, the combining steps can comprise taking an average of the values, a sum of the values, a geometric mean of the values, or can be done by Minkowski Pooling.

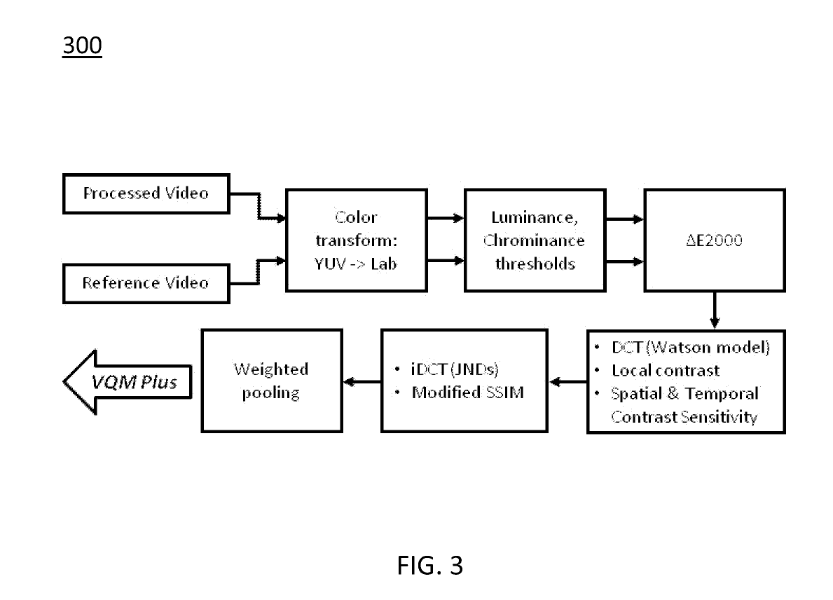

In addition to method 200, there are other embodiments that compare two videos using while considering the behavioral aspects of the HSV when viewing an image or sequence of images. As an example, FIG. 3 illustrates an example of a method 300 of determining the quality of similarity between two video according to another embodiment. Method 300 can also be considered a method of comparing compressing video data to the original video data while considering the behavioral aspects of the HSV when viewing an image or sequence of images. In some embodiments, method 300 can be considered a video quality metric. Method 300 is merely exemplary and is not limited to the embodiments presented herein. Method 300 can be employed in many different embodiments or examples not specifically depicted or described herein.

An inventive new HVS-based video quality metric has been developed that combines HVS spatial, temporal, and intensity-dependent sensitivities to chrominance, luminance, structure, and contrast differences. This inventive new metric, referred to here as VQM Plus, is both sufficiently comprehensive and computationally tractable to offer significant advantages for the development and standardization of new video codecs.

In certain exemplary embodiments, certain general components of the VQM Plus metric are based on:

1. Luminance and chrominance sensitivity model based on comprehensive experimental data

2. Model for color perception based on deltaE2000 in the CIE Lab color space

3. Spatial and temporal HVS sensitivity model based on the Webber-Fechner law

4. Use of the Watson frequency domain approach to extract local contrast information

5. Use of SSIM model to calculate the final distortion metric from local contrast information.

A high-level expression for aspects of an embodiment of the VQM Plus metric is given by:

VQMPlus=VQ(JND(SSIM(DVQ(ΔE(ΔL,ΔCHR)))))

Where VQ represents the weighted pooling method used to generate a final metric that is well-matched to subjective picture quality evaluation, JND denotes a just noticeable difference model based on Watson, SSIM is the Structural SIMilarity index proposed in, DVQ is the Watson DVQ model, ΔE quantifies perceptual differences in color via deltaE2000 in the CIE Lab color space, and ΔL and ΔCHR represent the luminance and chrominance Euclidian distances in the CIE Lab color space.

In certain embodiments, the color transforms in our calculations use the Lab/YUV color space in order to input raw video test data directly. The subsequent frequency transform step separates the input image frames into different spatial frequency components. The transform coefficients are then converted to local contrast (LC) using following equation:

$${LC}_{i} ( u , v ) = \frac{{DCT}_{i} ( u , v )}{D {C}_{i}} {( \frac{D {C}_{i}}{1024} )}^{0.65}$$

$$D {C}_{i} ( u , v ) = {DCT}_{i} ( 0 , 0 )$$

DCTᵢ denotes the transform coefficients, while DC; refers to the DC component of each block. For an input image with 8 bits/pixel, Qt=1024 is the mean transform coefficient value, and 0.65 is found to be the best parameter for fitting experimental psycho-physical data. These latter three steps are identical to Watson's DVQ model, after which the VQM Plus calculations model the HVS as follows.

Again, in certain exemplary embodiments the local contrast values, LCᵢ, can be next converted to JNDs by first applying a human spatial contrast sensitivity function (SCSF) adapted from, applying contrast masking to remove quantization errors, followed by a human temporal contrast sensitivity function (TCSF). The JNDs are then inverse transformed back into the spatial domain in order to calculate the structural similarity between the reference and processed image sequences. Finally, a modified SSIM process is then used to calculate VQM Plus as a weighted pooling of the above deltaE, contrast, and structure components. The resulting VQM Plus metric thus incorporates local spatial, temporal, and intensity-dependent HVS sensitivities to chrominance, luminance, contrast, and structure differences.

It is important to note here that the different quantization matrices applied in the spatial and temporal domains generate both static and dynamic local contrast values, LCᵢ(u,v) and LCᵢ′(u,v), which are converted to corresponding static and dynamic JNDs, JNDᵢ(u,v) and JNDᵢ′(u,v). The contrast in the original SSIM, is replaced here with C′, which is calculated from LCᵢ(u,v) and LCᵢ′(u,v).

SSIM′(u,v)=l(u,v)C′ᵢ(u,v)s(u,v)

l(u,v) and s(u,v) here are the local luminance and structure. The final pooling method generates differences between SSIM weighted JND coefficients to produce Diffᵢ(t) values.

$${Diff}_{i} ( t ) = {\sum }_{i = 0}^{M} {( {SSIM}_{t}^{′} ( {u}_{i} , {v}_{i} ) )}^{p}$$

where t is a region of M samples and p is the Minkowski weighting parameter as in Wang and Shang.

Dist_{Mean}=1000mean(mean(abs(Diffᵢ(t))))

Dist_{Max}=1000max(max(abs(Diffᵢ(t))))

VQMPlus=Dist_{Mean}+0.005*Dist_{Max}

Increasing VQM Plus values correspond to decreasing quality of the processed video signal with respect to the reference. A VQM Plus value of zero represents a processed video signal with no degradation (compared to the reference).

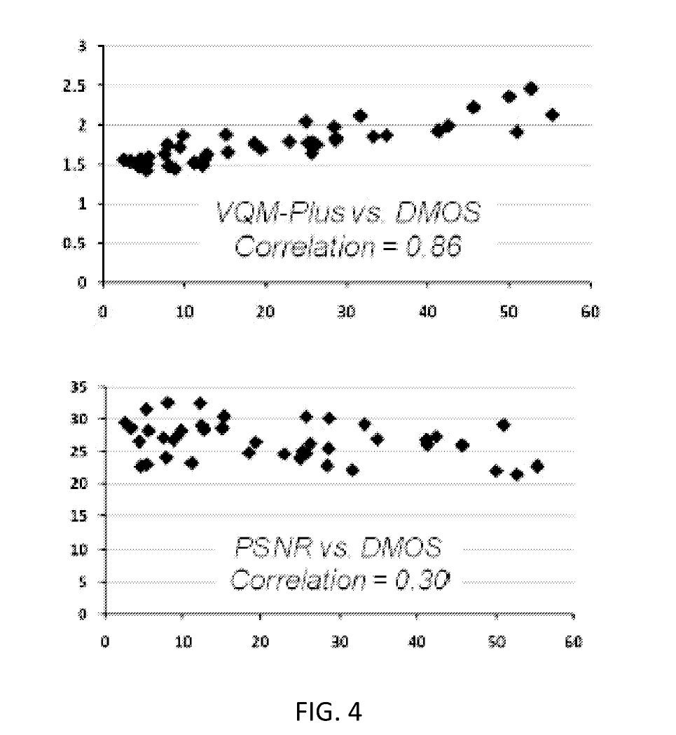

FIG. 4 presents an initial comparison of the performance of VQM Plus in higher-compression/lower-bit rate test situations where PSNR is known to have poor correlation with MOS scores. Five VCEG test sequences were included in these measurements, along with the corresponding published MOS scores; details are summarized in Table 1. Note that for each of the 5 reference sequences, the 9 compressed test versions corresponding to VCEG's “hypothetical reference circuits” 8-16 have been used, i.e. the highest compression levels and lowest bit rates. The correlation numbers shown in FIG. 4 correspond to the widely used Spearman rank order correlations test for agreement between the rank orders of DMOS and perceptual model predictions. VQM Plus achieves much higher correlation than PSNR.

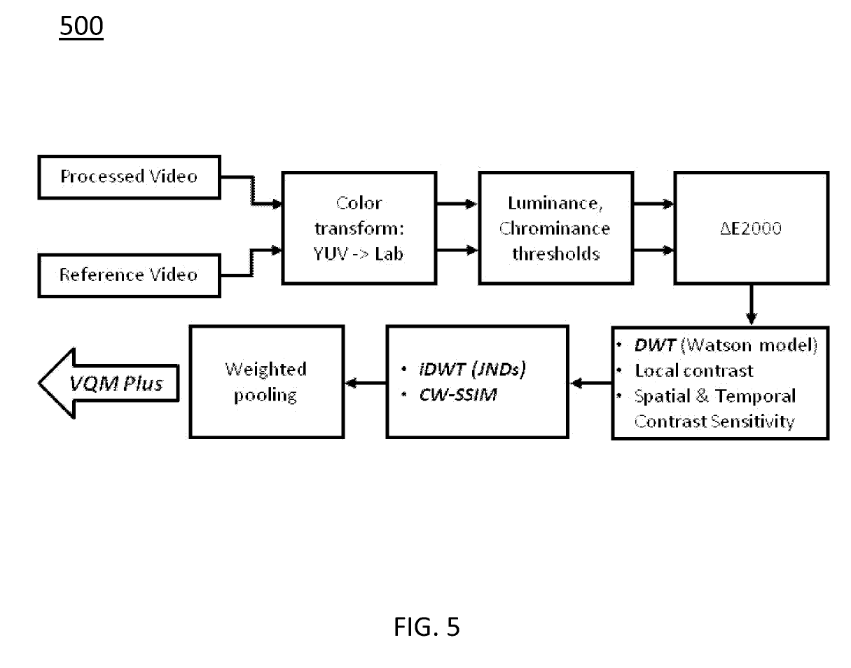

FIG. 5 illustrates an example of a method 500 of determining the quality of similarity between two video according to another embodiment. Method 500 can also be considered a method of comparing compressing video data to the original video data while considering the behavioral aspects of the HSV when viewing an image or sequence of images. In some embodiments, method 500 can be considered a video quality metric. Method 500 is merely exemplary and is not limited to the embodiments presented herein. Method 500 can be employed in many different embodiments or examples not specifically depicted or described herein.

Method 500 is similar to method 300; however, method 500 is modified to predict the variant HVS response to small geographic distortions. One embodiment utilizes a modified SSIM approach that can in certain instances better predict this invariance as may be indicated in improved Complex Wavelet Structural Similarity (CW-SSIM) index. This wavelet based model has been implemented in combination with a wavelet domain Watson DVQ model. These enhancements are shown in FIG. 5. Further enhancements also include important adaptive and non-linear HVS behaviors (including dark adaptation and masking of detail by objects in motion) beyond those described above.

The above disclosure of video quality metrics has been limited generally to the full-reference case, in which a frame by frame calculation is carried out comparing the reference video and the test video. This process generally requires that the entire reference video be available in an uncompressed and unimpaired format, which limits most video codec/video quality testing to constrained laboratory conditions. For example, the full reference case is generally not suitable for assessing important end-to-end system-level impairments of video quality, such as, for example, dropped frames or variable delays between the arrival of consecutive frames. In order to fit into the limited (and constantly fluctuating) transmission bandwidth typical of a real-time, two-way, mobile video sharing application, for example, the video received and displayed on the user's devices may fluctuate in space (image size), in accuracy (compression level), and in time (frame rate). Extended quality metrics are needed that can accurately assess the relative impact on human perception of changes in all these dimensions at once, to allow for rational allocation of bits between spatial and temporal detail. In order to fully predict the user's overall Quality of Experience (QoE) for a video device, application, or service, reduced-reference and no-reference metrics are also encompassed within the scope of the present invention.

In another embodiment, a method of analyzing complexity of codecs and other programs is illustrated. The method of analyzing complexity can also be considered a new complexity metric. As an example, the method can provide a way to anticipate the computational loading of existing or proposed codecs and, further, provides systems and methods for obtaining insight into architectural decisions in codec design that will have consequent computational loading results.

The method of analyzing complexity of codecs can assist in and can be utilized in the significant challenge in designing video codecs with lower computational complexity but which can support a wide range of frame resolutions and data formats, ever increasing maximum image sizes, and image sequences with different inherent compressibility. The overall complexity of such codecs is determined by many separate component algorithms within the video codec, and the complexity of each of these component algorithms may scale in dramatically different fashions as a function of, for example, input image size. Today's DCT transform and motion estimation codecs are already too computationally complex for many real-time mobile video applications at SD and HD resolutions, and are becoming difficult to implement and manage even for motion picture and broadcast applications at UHD resolutions.

Certain embodiments of the method of analyzing complexity of codecs account for the many important, real-world consequences of data-related scaling issues including:
Scaling with data volume: image size in pixels, image precision in bits/pixel, frame rate
Scaling with the statistical nature of intra-image (spatial) and inter-image (temporal) correlation and motion
Scaling according to platform-dependent restrictions such as operation availability, instruction set support, platform parallelism, bus speed and width, and size/speed of internal vs. external memory.

Embodiments of the method of analyzing complexity of codecs also allow estimation and measurement of all drivers of overall codec computational complexity, rather than simply counting machine cycles or arithmetic instructions in individual component algorithms. The dynamic run-time complexity of most of the component algorithms in a video codec is impacted by important data-dependencies such as process path alternatives and loop cycle counts.

In some embodiments the method of analyzing complexity of codecs is adapted to operate in an environment such that the metric is applied by software to the source code of an algorithm. Further, the metric can be applied by software to component modules of an algorithm and further to machine code embodiments of the algorithm adapted to run on certain hardware (such as an embodiment compiled to run on a specific platform). In addition, the system can be adapted to operate for software and hardware implementations suitable for embedded testing within encoders and decoders. In some instances it provides a single metric capable of expressing complexity in terms of several different measures, including total number of computational cycles, total runtime, or total power.

As an example, DCCM is herein defined as a dynamic codec complexity metric suitable for standards purposes as outlined here. The DCCM begins by reducing each algorithm in terms of its atomic elements, weighted by the number of bits operated upon. Three types of atomic elements are considered here: arithmetic operations, data transfer, and data storage. The first of these contributions is estimated by the number of elementary arithmetic operations that each algorithm can be reduced to, such as shift, add, subtract, and multiplication, along with corresponding logic and control operations, scaled by the number of bits operated upon, so that the resulting complexity is given in units of bits. The data transfer contribution, often omitted from computations of algorithm complexity, accounts for the number of elementary data transfers required between memory locations (read and write) or ports during execution of the algorithm, scaled by the number of bits transferred, so that the resulting complexity is again given in units of bits. The data storage contribution, measured in bits, accounts for the storage resources necessary to implement the algorithm.

For each algorithm within the codec, the static complexity is first determined for each branch of the algorithm; the overall static complexity will then be the sum of the complexities within each branch. Consider an algorithm whose data flow is represented by the set of branches illustrated below, with the corresponding static complexity Qᵢ^{sc} of each branch i given by the sum of the three basic complexities Qᵢ^{a} (arithmetic operations), Qᵢ^{t} (data transfer), and Qᵢ^{s} (data storage):

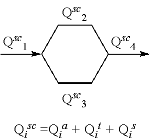

The overall static complexity Q^{sc} for the algorithm, in units of bits, is then given by:

Q^{sc}=Q^{sc}₁+Q^{sc}₂+Q^{sc}₃+Q^{sc}₄

It will sometimes be useful to utilize instead the three elemental static operation complexities Q^{a}, Q^{t}, and Q^{S}, for example when comparing implementations on multiple processor platforms with very different instruction sets, bus architectures, and storage access.

The above static complexity can also be expressed in terms of alternative measures (i.e. computational cycles, total runtime, or total power) by scaling each of the three elemental complexities Q^{a}, Q^{t}, and Q^{s} by an appropriate cost function tₐ, tₜ, and tₛ, (i.e. with units of computational cycles/bit, runtime/bit, or power/bit) and calculating the corresponding weighted sum:

I^{sc}=tₐQ^{a}+tₜQ^{t}+tₛQ^{s}

The dynamic complexity can be estimated from further analysis of the decision and branch structure of the algorithm, along with the static complexities and data statistics wⱼ of each branch. The data statistics determine how often each branch is executed in the algorithm, taking into account data dependent conditional loops and forks. The dynamic run-time complexity Q^{dc} of the algorithm can then be estimated as (in units of bits):

Q^{dc}=w₁Q^{sc}₁+w₂Q^{sc}₂+w₃Q^{sc}₃+w₄Q^{sc}₄

Finally, the above dynamic complexity Qdc can also be expressed in terms of alternative measures Idc by expanding each branch complexity Qisc in terms of its three elemental complexities Qia, Qit, and Qis, scaling these by their appropriate cost functions ta, tt, and ts, and calculating the corresponding weighted sum:

I^{dc}=w₁(tₐQ₁^{a}+tₜQ₁^{t}+tₛQ₁^{s})+w₂(tₐQ₂^{a}+tₜQ₂^{t}+tₛQ₂^{s})

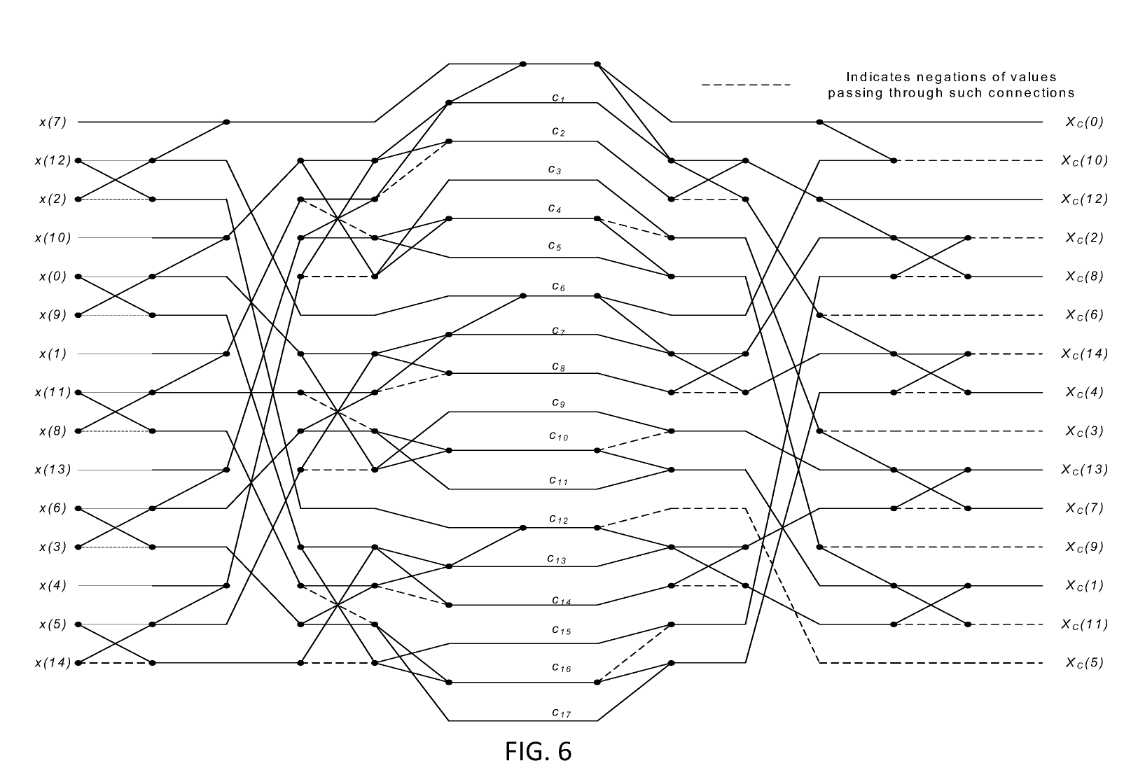

Let us consider a more complicated example of a real codec algorithm. The fast DCT factorization algorithm illustrated in FIG. 6 was proposed in, and the complexity of this algorithm was originally estimated in terms of atomic operations alone: 14 essential multiplications and 67 additions. According to the DCCM model above, however, the static complexity for this algorithm also contains 75 essential data transfers. The storage complexity is 17, since the computations are arranged in-place, and only coefficients need storage; input and output data storage are assumed to be handled outside of this algorithm. Assuming that the costs of all different operations and the data statistics of each branch are equal to one, and that the data used in the computation are 16 bit wide, the DCCM formula above gives the complexity metric for this algorithm as:

I^{dc}=((14+67)+75+17)*16=2768

The DCCM metric proposed above can serve as a basis for comparative analysis and measurement of codec computational complexity, both at the level of key individual algorithms and at the level of complete, fully functional codecs operating on a range of implementation platforms.

In another embodiment, a codec capable of being deployed in high-quality, low-bit-rate, real-time, 2-way video sharing services on mobile devices and networks using an all-software mobile handset client application that integrates video encoder/decoder, audio encoder/decoder, SIP-based network signaling, and bandwidth-adaptive codec control/video transport via real-time transport protocol (RTP), and real-time control protocol (RTCP) is illustrated. The all-software DTV-X video codec utilized in the above mobile handset client leverages significant innovations in low-complexity video encoding for compression, video manipulation for transmission and editing, and video decoding for display, based on Droplet's 3D wavelet motion estimation/compensation, quantization, and entropy coding algorithms.

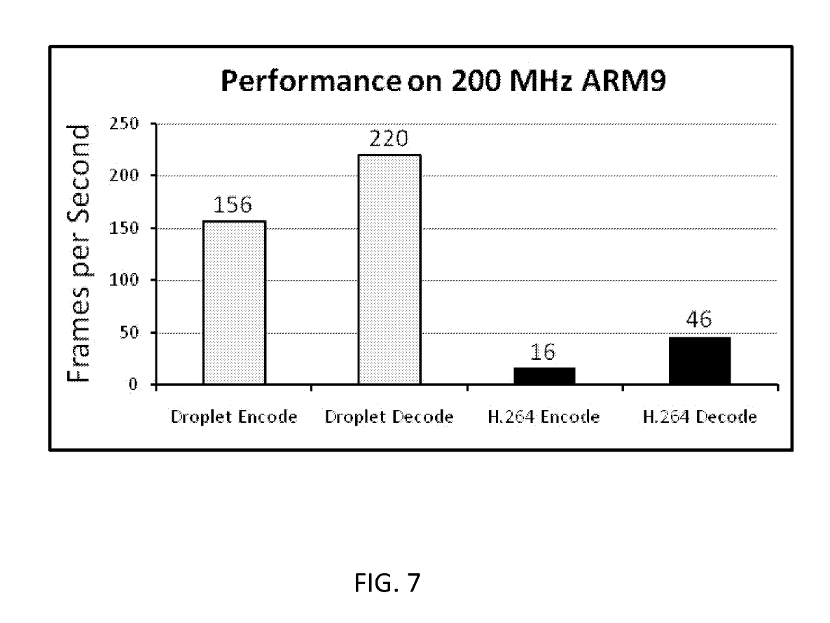

As illustrated in FIG. 7, Droplet's DTV-X video codec achieves a 10× reduction in encode computation and a 5× reduction in decode computation compared to leading all software implementations of H.264 video codecs. Software implementations of H.264 video codecs, even after extensive optimization for operation on the ARM9 RISC processors found in mobile handsets, are still only able to achieve encode and decode of “thumbnail size” QCIF images (176×144 pixels). The codec was further tested on OMAP-based cell phones, and Droplet's DTV-X software video codec supports real-time encode and decode of full VGA (640×480 pixels) video at 30 fps on the same ARM9 RISC processor, which represents a major breakthrough in rate-distortion performance vs. computational complexity.

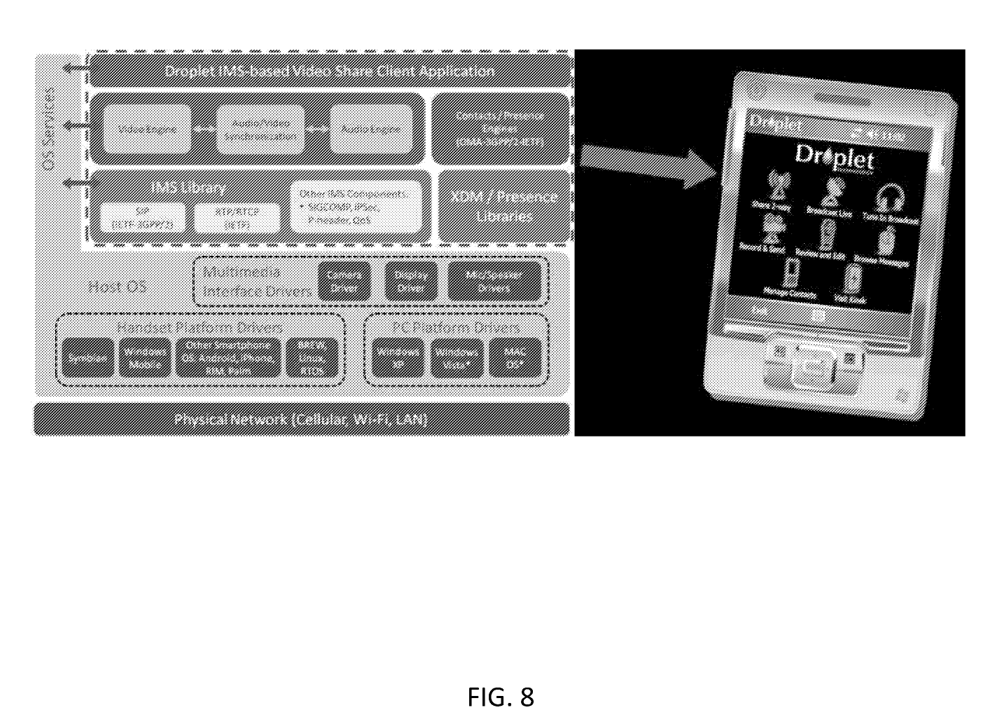

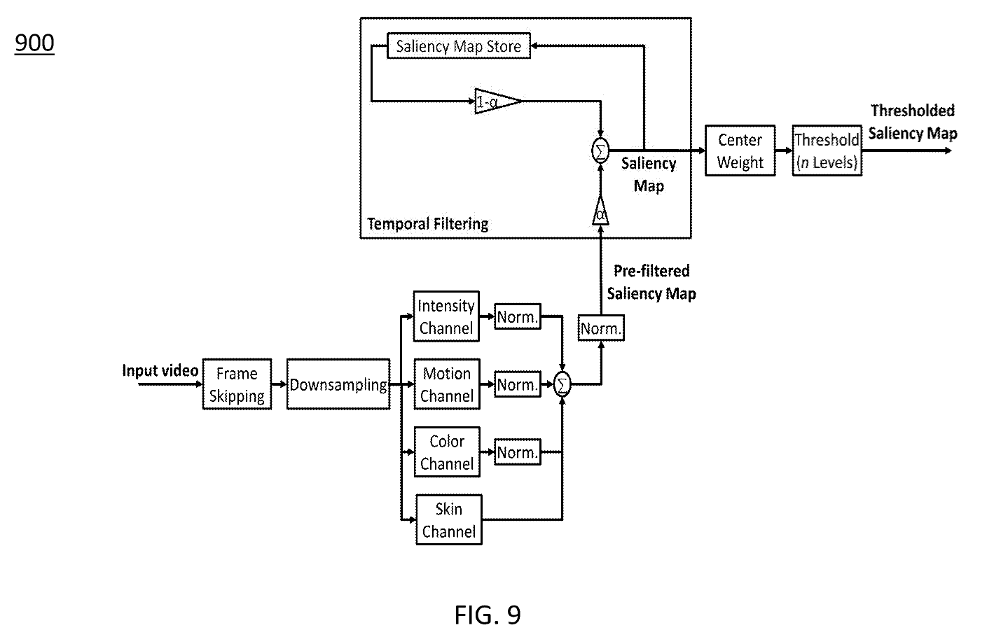

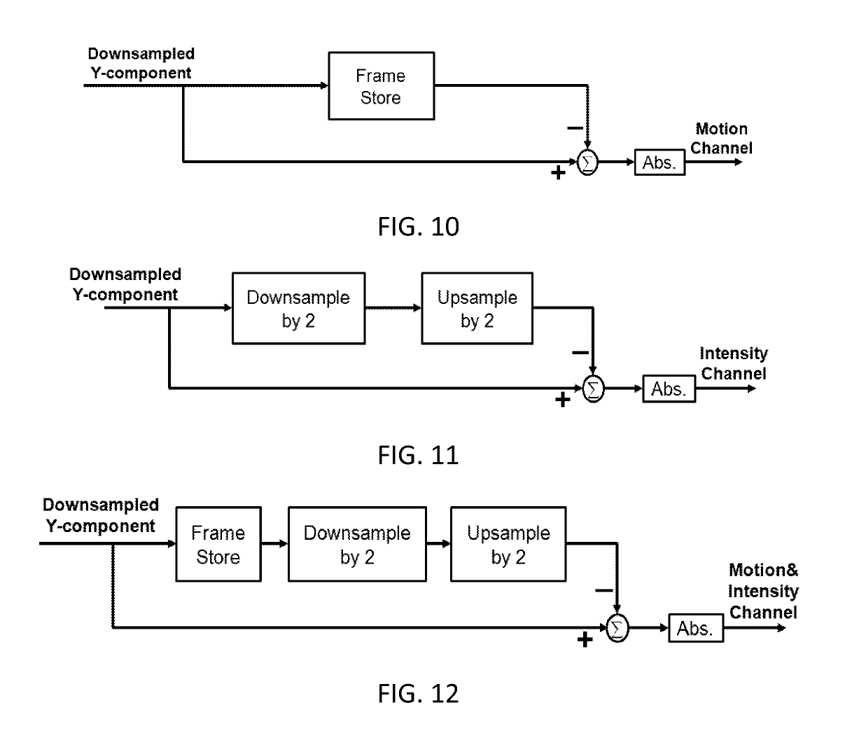

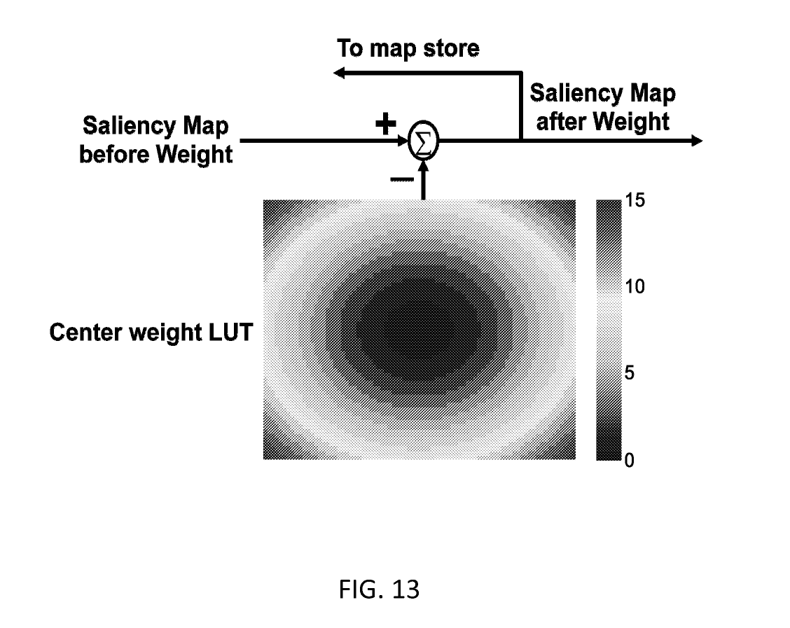

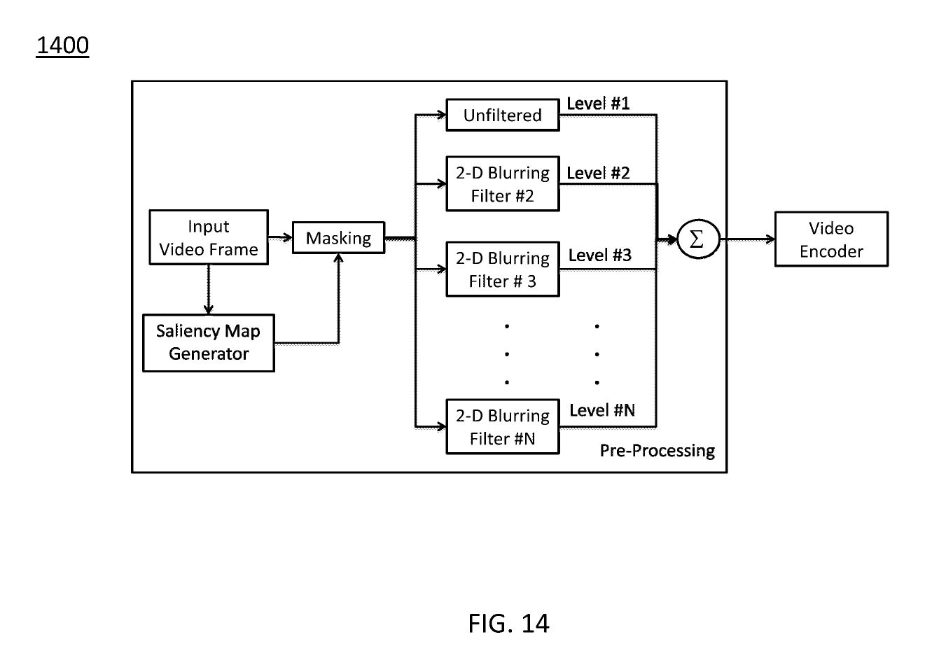

An advantage of the present codec is illustrated in FIG. 8, in which the video codec function can then be combined with all the other audio processing components, audio/video synchronization components, and IP multimedia subsystem (IPMS), network signaling components, real time transport protocol components and real time control protocol components, into a single all software application capable of running on the standard application processors of current mobile phones without any specialized hardware components.

Additional embodiments of the present invention may also include the use of masks or probes to define different codec architectural approaches to encoding particular video sequences or frames.

In video codecs, two major architectural forms are:

a) T+2D, where temporal prediction (“T”) is performed followed by a spatial transform (“2D”) of the prediction residuals, and

b) 2D+T, where a spatial transform is performed followed by temporal prediction of the transform coefficients.

These are generally regarded as exclusive, and a particular video codec generally may follow one or the other but not both forms.

Certain embodiments and implementations of the present invention present a new and inventive architecture in which the decision between T+2D and 2D+T processing can be made dynamically during operation, and further can be decided and applied separately for different regions of the video source material. That is, the decision may vary from place to place within a frame (or image), from frame to frame at the same place, or any combination of the above.

Typically, a T step performs a prediction of part of the current frame using all or part of a reference frame, which may be the previous frame in sequence, an earlier frame, or even a future frame. In the case of using a future frame as reference, the frames must be processed in an order that differs from the capture and presentation order. Additionally, the prediction can be from multiple references, including multiple frames.

Given a prediction for part of a current frame, the coding process subtracts the prediction from the current data for the part of the current frame yielding a “residual” that is then further processed and transmitted to the decoder. The processed residual is expected to be smaller than the corresponding data for the part of the frame being processed, thus resulting in compression.

Typically, a reference frame may also be a frame that is generated as representative of a previous or future frame, rather than an input frame. This may be done so that the reference can be guaranteed to be available to the decoder. (For example, the reference frame is the version of the frame as it would or will be decoded by the decoder.) If alternatively, for example, the input frame is used as the reference, the decoder may accumulate errors that the encoder fails to model; this accumulation of errors is sometimes called “drift”.

According to certain embodiments of the present invention, a video codec can process a frame of data by taking the following general steps:

a) Examine the frame by probing regions associated with the frame to find those regions, if any, that favor 2D+T coding and to find other regions, if any, that favor T+2D coding, and possibly for regions that favor other coding forms;

b) Encode each region with its favored coding form.

In some embodiments, a coding form is deemed favored when applying it will result in better compression performance. We have inventively discovered that regions having different characteristics are intrinsically favored by different coding architectures. By dynamically examining regions of video (whether spatial regions of a frame or spatial, regions across a sequence) and applying the specifically favored coding form for respective regions reduced codec complexity (computational load) and/or increased compression can be achieved. The map of the results of the dynamic examination, or probing, of regions of the video or frame can in some instances be termed a map or mask as used herein. The maps or masks generated as described below can in some instances also be used in the several variations of applied coding techniques described earlier herein.

Techniques for probing may include sum of absolute differences (“SAD”) applied between a reference region and a current region or the sum of squared differences (“SSD”) similarly applied between a reference region and a current region. SAD and SSD probes when applied provide a measure of a factor termed herein as “Change Factor (“CF”)”. The limit of CF would occur when the reference region exactly matches the current region. This case is referred to as “static”. It should be noted that SAD and SSD probes are applied between a region of a current frame and a portion or portions of a reference frame or reference frames.

Another type of probe is shown by the inventive probe termed herein as “sidewise SAD (“SSAD”)” which comprises calculating absolute differences between pixels that are adjacent horizontally or vertically in a region of a frame, and summing these absolute differences. Stated in other language, the technique takes absolute differences between adjacent rows and between adjacent columns and sums the absolute differences. This results in a measure of “roughness factor (“RF”)” of the region. Another inventive probing method is “sidewise SSD (“SSSD”)” (which is a parallel analysis but using the squared value of each difference rather than the absolute value of each difference) which also results in a measure of RF of the region. The limit of RF would occur when the region exactly matches itself. This case is referred to as “uniform”—or in other words, when all pixels in the region have the same value. A low RF factor of a region would indicate “smoothness” as that term is typically used in the compression field. It should be noted that SSAD and SSSD probes are applied to a region within a single frame. It should be further noted that SSAD and SSSD are only exemplary techniques to determine RF, which may also be determined by other probe techniques.

A lower value from probes indicating CF recommends application of a T+2D codec architectural form. Similarly, a lower value from probes indicating RF recommends application of a 2D+T codec architectural form. In some embodiments probes indicating both RF and CF are applied to a region and the relative magnitude of the respective RF and CF indications determines the choice of architectural form applied to the region.

In some embodiments, when a strong RF or CF indication is obtained for a specific region the probe first applied to the corresponding region in one or more succeeding frames is that which resulted in the strong RF or CF indication. If the RF or CF indication is of sufficient strength, then the alternate probe technique need not be applied to the specific region (because the strength of the indication is deemed sufficient to recommend the codec architectural form to be applied). In some embodiments a weighting is applied to measured CF and RF factors and the selection between T+2D or 2D+T architectural forms is made based on comparison of the weighted factors.

More than one probing technique can be applied to a single region or frame.

In certain embodiments, the probing technique need not examine every pixel in a region. Instead, it may examine a representative sample or samples of the region. For example, a checkerboard selection of pixels in the region can be used. Other sampling patterns can also be used. In some embodiments, different sampling methods can be used for different probes.

For the regions that favor 2D+T, in some embodiments we can apply a spatial transform step (typically a DCT (Discrete Cosine Tranform) or DWT (Discrete Wavelet Transform)) prior to applying a temporal prediction step (typically Motion Estimation (“ME”) and Motion Compensation (“MC”)). As a variation, the 2D step may render the T step unnecessary, in which case it may be omitted for the region.

For the regions that favor T+2D, in some embodiments we apply a temporal prediction step prior to applying a spatial transform step. As a variation, the T step may render the 2D step unnecessary, in which case it may be omitted for the region. Some embodiments enable a simplification of the 2D step. For example, the simplified 2D step may omit calculation of some transform coefficients. As a further example, in the instance of a DWT the calculation of entire subbands may be omitted.

In either case, there may be other processing steps applied before, between, or after the given T and 2D steps.

A spatial region may be a block, a macroblock, a combination of these, or any general subset of the image area. A space-time or spatio-temporal region is a set of regions in one or more images of the video; it may be purely spatial (entirely within one frame).

In some instances the CF indicator is sufficiently small (below another threshold) that it is favored to omit the 2D step. The data is further processed without being spatially transformed. A significant advantage of this method is that compression can be achieved with fewer calculation steps and the ultimate compressed video sequence can have fewer bits than if the method were not used.

In another example, we may identify a spatial region that has a low RF indicator (i.e., is very smooth) as favoring 2D+T processing. In this case we would apply the 2D spatial transform first.

In a refinement of this example, we may apply the 2D spatial transform stepwise, as for instance by doing wavelet transform steps one at a time, and after each (or some set) of transform steps, again identify whether the resulting transformed region should be further processed using 2D steps or a T step. A significant advantage of this method is that compression can be achieved with fewer calculation steps and the ultimate compressed video sequence can have fewer bits than if the method were not used.

In an additional feature and embodiment, in instances where a relatively large motion is recognized for a region or block we inventively can apply the codec in such a way as to transmit reduced detail information for the region of relatively large motion. It has been found that the human perception of regions in rapid motion does not perceive a relatively high degree of detail. Accordingly, detail data of those regions can in some instances and/or embodiments be reduced by operation of the codec. One indicator of relatively large motion for a region is a motion vector magnitude corresponding to the region that exceeds a predetermined threshold. One technique to reduce the detail transmitted for the region is to reduce or omit transform coefficients or subbands corresponding to high frequencies for the region. Such reduction could, in some cases, be carried out by adjusting quantization parameters applied to the relevant data, such as by increasing quantization step sizes.

FIGS. 8 and 9 show results of another aspect of the present invention. These figures show the same frame of a video processed identically except that in FIG. 8 the allocation of bits among subbands implanted by quantization weights for each subband differs from the allocation among subbands in FIG. 9. In FIG. 9 the relative quantization of the subbands is more nearly equal between subbands than in FIG. 8. FIG. 9 thus shows much higher visual quality and detail. Both FIGS. 8 and 9 have substantially the same number of bits in their compressed representation.

Embodiments of the present invention may comprise a method of compressing video by:

a) Defining a region in the video;

b) Applying a probe to the region to determine a CF indication and second probe to determine an RF indication for the region;

c) Based on comparison of the CF and RF indications, selecting a codec architectural form to apply to the region;

d) Applying the selected codec architectural form to the data of the region.

Embodiments of the present invention may comprise further weighting the CF indication and RF indication to facilitate comparison of the indications.

Embodiments of the present invention may comprise applying a probe to selected samples of a region.

Embodiments of the present invention may comprise preferentially applying a probe technique to a region for which the probe factor of a related region has previously resulted in a preferred probe indication.

In some embodiments of the present invention, when the probe indicator suggests favorability of a codec having a D2+T architectural form, a codec of the fashion described in Exhibit A, hereto can be employed. Exhibit A, includes as subparts thereto, FIGS. 1-4B, and Exhibits B1, B2, C and D. Codecs as described in Exhibit A can be applied selectively to separate regions of the video.

With the capability and advantages of the all software solution described above, embodiments of the present invention provide a system in which the software solution can be loaded onto virtually any mobile handset and a variety of video services enabled to that and other handsets. Such services include real time two way video sharing, mobile to mobile video conferencing, and mobile to internet video broadcasting. In some embodiments the system includes a hosted interactive video service platform which can provide interoperability between multiple mobile operator networks. Additionally, the complexity advantages are realized at the interactive video service platform.

In yet other embodiments, methods of computing salience maps are disclosed. The saliency maps are used in the compression of video data. Saliency is defined as the degree to which specific parts of a video are likely to draw viewers' attention. A saliency map extracts certain features from a video sequence and, using a saliency model, estimates the saliency at corresponding locations in the video. Areas in a video that are non-salient are likely to be unimportant to viewers and can be assigned a lower priority in the distribution of bits in the compression process through many possible mechanisms. Aspects of this invention emphasize the fast and extremely low-complex generation of a saliency map and its integration into a codec in a manner that achieves reduced computational complexity and bitrate at a similar perceptual quality.

FIG. 9 illustrates a block diagram of an example of a low-complexity saliency map generation method, method 900. Method 900 is merely exemplary and is not limited to the embodiments presented herein. Method 900 can be employed in many different embodiments or examples not specifically depicted or described herein.

Method 900 includes a procedure of frame skipping. Frames adjacent in time tend to be highly similar and in relatively static scenes it may be unnecessary to compute a new saliency map for each frame. As such, a new saliency map can be computed at certain frame intervals only. Frames at which saliency maps are not computed are said to be “skipped” and can be assigned a map estimated from the nearest available map via simple copying or an interpolative scheme. Skipping frames reduces the computational complexity of the saliency map generation process but, when used too often, can introduce some lagging which arises from difficulty in tracking rapid changes in the scene.

Method 900 also includes a procedure of downsampling. In order to reduce the complexity of the saliency map generation, the scale of the original video frame may be first reduced through downsampling. Downsampling reduces the number of pixels necessary to operate on, and hence overall computational complexity, at the cost of possible loss of detail. These details may or may not be significant in the overall saliency map depending on video characteristics or features or interest. The factor of downsampling can be decided dynamically as a function of video resolution, viewing distance, and/or scene content.

In addition, method 900 comprises a procedure of feature channel extraction. The pre-filtered saliency map is estimated by combining saliency information from several feature channels. Individual feature channels model the human psycho-visual response to specific characteristics in the video sequence. There exist many possible feature channels, and in some embodiments, the channels are selected on the basis of their importance and low computational complexity. Several such candidate channels are described below.

Color

The color channel takes into account the varying degrees of visibility between different colors. In particular, bright colors tend to attract more attention and hence contribute more to the saliency at its location. In one embodiment, the space of chromaticity as combinations of the U and V components can be directly mapped to a saliency value. The mapping is based on models of the human visual response to colors.

Motion and Intensity

The motion channel measures the tendency of the human visual system to track motion. Embodiments of this can involve computing the absolute frame difference between the current frame and the previous. Alternatives include a full motion search across blocks in the frame that derives a motion vector representing the magnitude and direction of movement. Frame difference does not measure the magnitude of the motion, but can be a simple indicator of whether or not motion has occurred. FIG. 10 shows an example of an embodiment of the motion channel.

The intensity channel responds with a high value when distinct edges in the video frame are present. One embodiment of this channel involves subtracting a frame from a coarse scale version of itself. By taking the absolute value of the difference, the value tends to be large at sharp transitions and edges and otherwise small. The coarse scale frame can be obtained by downsampling then upsampling (usually be 2) a frame using suitable interpolation techniques. FIG. 11 shows an example of an embodiment of the intensity channel.

In addition the motion and intensity can be combined into a single channel that responds to both movement and edges. This may be implemented by performing the frame absolute difference with a coarse-scale version of the previous frame. Such a channel has the advantage of being of lower computational complexity than the two channels if they were to be computed separately. While the combination is not perfectly equivalent, its effect on the output saliency map is negligible. FIG. 12 shows an example of an embodiment of the ‘Motion and Intensity’ channel.

Skin

The skin channel partially accounts for the context of the video sequence by marking objects with human skin chromaticity, particularly human faces, as highly salient. Such a channel ensures that humans are assigned a high priority even when lacking in other features of saliency. In one embodiment of the skin channel, a region of chromaticity expressed as combinations of U and V values is marked as skin. A sharp drop-off is used between the skin and non-skin region to reduce the likelihood of false positives. This channel may not be subjected to further normalization as the objective is to only detect whether a given location is of skin color or not.

Method 900 also comprises a procedure of normalization. Following the computation of each feature channel, normalization may be applied to ensure that the saliency values are of the same scale and importance. This removes the effect of differing units of measurement between channels. A low-complexity choice is linear scaling, which maps all values linearly to the scale of 0-1. Alternative forms of normalization that mimic the human visual response may choose to scale the values based the relative difference between a point and its surroundings. Such normalization amplifies distinct salient regions while placing less emphasis on regions of relatively smooth levels of saliency features.

In addition, method 900 also comprises a procedure of linear combination. The features channels are linearly combined to form a pre-filtered saliency map. The linear weighting for each map can be fixed or adaptive. The adaptive weights can be adjusted according to the setting and context of the input scene and/or the usage of the application. Such weighting can be trained statistically from a sequence of images or videos for each type of video scenes.

Furthermore, method 900 includes a procedure of temporal filtering. After all feature channels are combined to form a pre-filtered saliency map, a temporal filter is applied to maintain the temporal coherence of the generated saliency map and mimic the temporal characteristics of the human visual system. At each video frame interval, the previous saliency map, which is generated from the previous frame, is kept in the saliency map store and linearly combined with the current pre-filtered saliency map. The linear weighting of this temporal filter is adaptive according to the amount of frame skipping, input video frame rate and/or output frame rate. FIG. 13 illustrates a map of the center weight LUT that shows an example of how to determine and perform the weighting bias.

Furthermore, method 900 comprises a procedure of center weight biasing. After the filtered saliency map is generated, a center-weight bias is subtracted from the saliency map in a pixel-wise manner to yield higher salient values around the center of the scene. The center-weighting bias is implemented using a center-weight look-up table (LUT). Each entry of the center-weight LUT specifies the bias value for each spatial location (pixel) of the saliency map. To give a higher priority to the center, set the bias value around the center of the LUT to be zero, and gradually increase the bias as you move away from the center. The value of center-weight can be adaptively adjusted according to the setting and the context of the input scene and/or the purpose of the application. The values of LUT can be trained statistically trained from a sequence of images or videos for each type of video scenes.

Method 900 can also include a procedure of thresholding. The value of the saliency map at each spatial location can determine the importance of the visual information to the users. Different applications of the map may require different levels of precision in the measure, depending on its use and purpose. Therefore, a thresholding procedure is applied to the saliency map to assign each salient output value an appropriate representation level as required by the application. The mapping of each representation level is specified by a pre-determined range of the output salient values and can be a binary-level or a multi-level representation.

After a saliency map is generated, the video can be pre-processed (pre-conditioned) using the saliency map. FIG. 14 illustrates an example of a method 1400 of pre-processing. Method 1400 is merely exemplary and is not limited to the embodiments presented herein. Method 1400 can be employed in many different embodiments or examples not specifically depicted or described herein.

A pre-processing step method can be applied to reduce encoding bit-rate on the non-salient regions of an input video. This bit-rate reduction can be achieved by increasing spatial redundancies or spatial correlation of the pre-coded values on the non-salient region. Image blurring is one of the operations that can be utilized to increase the spatial correlation of the pixels. Blurring can be performed by using a 2-D weighted average filter. Such filter will introduce blurring effects and reduce the visual quality of the non-salient region that may not be focused by the viewers.

Since each spatial location has different degrees of saliency, one can vary the degrees of the blurring effect to reduce the possibility of visual quality loss that is perceptually noticeable to the viewers. The varying degree of blurriness is synthesized by using different filters with different parameters.

According to method 1400, first, a multi-level saliency map is generated for the input video frame. Second, overlay this saliency map over the input video frame as a mask. Each region or pixel of the input video frame will get assigned to a specific saliency level according to the mask. At each saliency level, a different 2-D filtering operation on the corresponding region/pixel is performed. Let denote level #1 as the most salient level and level #N as the least salient region. To achieve different degree of blurriness, level #1 can be left unfiltered to prevent visual quality loss and perform filtering from level #2 to level #N with increasing degree of blurriness by adjusting the parameters of the filter. Therefore, the region with salient level #N will have the highest blurring effect and will generally take up the least encoding bit-rate.

After the filtering operation is completed for each region, combine the filtered outputs linearly and output the processed frame to a video encoder. Overall, this pre-processing technique can be viewed as a preemptive bit-rate allocation independent from the rate-control mechanism of the video codec.

After pre-processing the saliency map can be used during the video coding operation. Using the saliency map, one can reduce the video encoder and video decoder complexity and/or reduce the bit-rate spent on the non-salient regions. The proposed modifications are generic and can be applied to any video coder.

Most video coding techniques have different modes to apply on different blocks in the scene. Some modes are more suitable for blocks with low motion activity and few high-frequency details, while other modes are suitable for blocks with high motion activity and more high-frequency details. The video encoder should try different modes and choose the best mode to apply on a given block to optimize both the bit-rate spent and the distortion that results on the block. Modern encoders have many modes to test, making mode decision a costly operation.

For fast mode selection, the video encoder may be modified to reduce the number of modes for the non-salient blocks. Since non-salient blocks usually have few and non-interesting details, the encoder can be forced to test only the modes known to perform better for low motion activity blocks. This enforcement will significantly decrease the encoder complexity at the cost of a slight increase in bit-rate since the chosen mode may not be optimal.

During motion estimation, the encoder applies a certain motion search algorithm to choose the best motion vector and represents the current block as a translated version of a block in a previous frame. The difference between the two blocks is referred to as the motion compensation residual error. This residual error is encoded and sent to the decoder along with the value of the motion vector so the decoder can reconstruct the current block. In general, motion estimation is considered an expensive operation in video coding.

For the non-salient blocks, reduce the search range and allow fewer motion vectors for the encoder to choose from. This technique will reduce the encoder complexity. Based on the fact that non-salient blocks usually have limited motion, the accuracy of the motion vector decision is mostly not affected by reducing the search range.

Residual skip mode is designed to reduce the bit-rate of the video and the complexity of both video encoder and decoder without degrading the perceived visual quality of the input video. To encode a residual frame, one needs to perform image transform, quantization and entropy encoding before outputting the data to the compressed bit stream. To decode a residual frame, perform entropy decoding, inverse quantization and inverse image transform. During the encoding process, small residuals are often quantized to 0 and do not contribute to the quality of the decoded video frame. However, the encoder and the decoder will still spend the same number of computation cycles to encode and decode the residuals.

The residual skip mode can be introduced in order to eliminate some of the unnecessary encoding and decoding operations on the residual frame. The basic operation of this mode is to quickly evaluate the output visual quality contribution of the residuals at each region of the video frame. If the quality contribution is low, the normal encoding and decoding procedures can be skipped with minimal impact to overall perceived quality. These encoding and decoding procedures include image transform, quantization, entropy encoding, entropy decoding, inverse quantization, inverse image transform. When a region with non-contributing residual is detected, the encoder will simply tag a special codeword in the bit stream to signify the ‘residual skip’ mode for that region. On the decoder side, the decoder will recognize this special codeword and assign residuals as 0 at that region without going through the normal decoding process.

To determine whether a residual skip mode is needed for each region, quickly evaluate the sum of absolute differences (SAD) between the current encoding region and the predicted region (extracted from the predicted frame). If SAD is below a pre-determined threshold, then the residual skip mode is enabled for that region. This threshold is determined experimentally and is set according to the size of the region, the quantization parameter, and/or output range of the pixel value. Furthermore, the threshold can also be adaptively driven by the salient values of the input frame. At regions with low salient value, one can set a higher threshold compared to the regions with relatively higher saliency because the residuals at those regions usually contribute less to the overall perceptual visual quality. By quickly evaluating the quality contribution of the residuals based on saliency and other factors, residual skip mode can simplify the encoding and decoding steps for a video codec.

The accuracy of the motion vector can vary from full pixel accuracy, which means that the motion vectors are restricted to have integer values, to sub-pixel accuracy. This means that motion vectors can take fractional values in steps of ½ or ¼.

Full pixel accuracy can be used for the non-salient blocks. Forcing the full pixel accuracy reduces the encoder complexity by searching fewer values of candidate motion vectors. Full pixel accuracy will increase the magnitude of the motion compensation residual error, and following the ‘residual skipping’ mentioned above, the result has more artifacts in the non-salient regions. These artifacts are generally tolerable as they occur in regions of less visual importance.

Although the encoder performs full pixel motion estimation for the non-salient regions, sub-pixel motion estimation is still applied for the salient regions. Video encoders need to interpolate the reference frame at the sub-pixel positions in order to use the interpolated reference for sub-pixel motion search. In practical implementations of video standards, the interpolation operation is usually performed on a frame level, meaning that the whole reference frame is interpolated before processing the individual blocks.

If the number of non-salient blocks in the video frame exceeds a certain threshold, then the whole frame can use full pixel motion estimation. Using full pixel motion estimation for the whole frame reduces the complexity at the encoder not only be searching fewer values of candidate motion vectors but also by not performing the interpolation step needed for sub-pixel motion estimation. Moreover, the decoder complexity is also reduced by skipping the same interpolation step at the decoder as well. Notice that the block level and the frame level full pixel decision can be performed simultaneously in one framework.

In a typical video encoder, either the pixel values or the intra prediction residual values (for an I-frame) or the motion compensation residual values (for a P-frame or a B-frame) pass through a ‘linear transform’ step as Discrete Cosine Transform (DCT) or wavelet transform. This is followed by a ‘quantization’ step where the resolution of the transformed coefficients is reduced to improve compression. The final step is ‘entropy coding’ where the statistical redundancy of the quantized transform coefficients is removed.

The decoder should perform the inverse operations in a reverse order in order to decode and reconstruct the video frame. The quantization step is a lossy step. That is, when the decoder performs the inverse operation, the exact values available at the encoder before quantization are not obtained. Increasing the quantization step reduces the bit-rate spent to encode a certain block but increases the distortion observed when reconstructing this block at the decoder. Changing the quantization is the typical method used by which video encoders perform rate control.

One can increase the quantization step for non-salient blocks by a certain offset. This reduces the bit-rate spent on these blocks at the cost of increased distortion. Unlike residual skipping, using a quantization offset for non-salient blocks will not reduce the encoder complexity because the transform, quantization and entropy coding operations are still performed. It is still useful, however, for decreasing the residual even when it is too high to apply skipping.

The quantization offset is applied to all frame types (I-frames, P-frames and B-frames). Since I-frames are used for predicting subsequent frames, it is beneficial to assign a relatively higher quality to them so that the quality degradation does not affect subsequent frames. As such, the offset in quantization steps in an I-frame is typically smaller than that used for P-frame or B-frame.

Since most video coders process the video in a block based manner, blocking artifacts may result at the block edges, especially at low bit-rates. Some video coders use a deblocking filter to remove these blocking artifacts. The deblocking filter can be switched off for non-salient blocks to reduce the complexity at both the encoder and the decoder sides. These blocking artifacts are less noticeable as they occur in regions that tend not to attract visual attention.

Recent video coding standards introduce tools that enable the encoder to divide the video frame into different slices and encode each slice independently. This allows providing better error-resilience during video streaming since an error will not propagate beyond slice boundaries. The error free slices can also be used to perform error concealment for the error prone ones.

This idea can be integrated with the saliency map concept by grouping the blocks corresponding to a certain saliency level into one slice. This allows the encoder to provide different error protection strategies and different transmission priorities for salient versus non-salient blocks. Since the slice is a video encoding unit, many encoding decisions can be made on a slice level, facilitating the implementation of all the previously described techniques.

H.264 is the state-of-the-art video coding standard. As a proof of concept, the modifications were implemented on JM software, which is the H.264 reference software. For simplicity, we only assume I and P-frame types, although all modifications are still valid in case of B-frames. The proposed modifications are applied as follows:

1. Fast Mode Selection: Non-salient blocks in an I-frame are forced to use 116×16 mode. Non-salient blocks in a P-frame are forced to use either P_{—}16×16 or P_SKIP mode.

2. Reduced Motion Estimation Search Range: The motion search range of the non-salient blocks is reduced to half of that used for salient blocks. Using a search range of 16 for salient blocks and 8 for non-salient blocks provides a good trade-off between reducing the encoding complexity and keeping the efficiency of the motion estimation operation.

3. Residual Skipping: Intra prediction residuals and motion compensation residual are skipped the way described in ‘residual skipping’ sub-section. Intra prediction residuals use different threshold values from those used for motion compensation residuals.

4. Block Level Full Pixel Motion Estimation: Salient blocks use ¼ pixel accuracy while non-salient blocks use full pixel accuracy.

5. Frame Level Full Pixel Motion Estimation: If the number of non-salient blocks exceeds a threshold, whole frame uses full pixel accuracy.

6. Quantization Offset: H.264 uses ‘quantization parameter (QP)’ to define the quantization step. From our experiments, in an I-frame, the QP of the non-salient blocks is higher by 2 than the QP of the salient blocks. In a P-frame, the QP of the non-salient blocks is higher by 5 than the QP of the salient blocks. These numbers need not be fixed and can be chosen adaptively based of the encoding conditions.

7. Switching off Deblocking Filter: Switch off H.264 deblocking filter in both encoder and decoder for the non-salient blocks.

8. Slice Grouping of Non-salient Blocks: H.264 provides a tool called ‘Flexible Macroblock Ordering (FMO)’ that enables to define slice groups in an arbitrary configuration. These slice groups can change from frame to the next by signaling the new groups in the ‘Picture Parameter Set (PPS)’ of the encoded frame. You can make use of these tools to define two slices every frame; one slice contains the salient blocks and the other contains the non-salient blocks.

Some of the previous proposed modifications require that the saliency map be known to decoder such that the proper inverse operation can be applied to decode the block. For example, in order to perform inverse quantization, the quantization step must be known, which may have been offset depending on whether the block was marked salient or non-salient. This requires the transmission of the saliency map along with the encoded video. The saliency map has much smaller dimensions and fewer number of intensity levels than the corresponding video frames. Also, the use of temporal filtering ensures that the map does not have much change from frame to frame, introducing significant temporal redundancy. As such, the saliency map can be compressed in a lossless manner at a negligible bit-rate relative to the video sequence.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. To one of ordinary skill in the art, it will be readily apparent that the methods discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment of the invention, and may disclose alternative embodiments of the invention.

All elements claimed in any particular claim are essential to the invention claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A method of compressing video data, comprising:
constructing a saliency map; and
applying the saliency map to video coding.

2. A method of compressing video data, comprising:
constructing saliency map;
pre-conditioning video data; and
applying the saliency map to video coding.
